(19) United States
(12) Patent Application Publication
(10) Pub. No.: US 2011/0189633 A1
(43) Pub. Date: Aug. 4, 2011

(54) DENTAL IMPLANT WITH FEMALE FRUSTOCONICAL CONNECTOR

(75) Inventors: Eric SCHNECK, Lyon (FR); Bernard CHAPOTAT, Vienne (FR); Ludovic LAVAL, Villeurbanne (FR); Romeo CASIMIRO, Francheville (FR)

(73) Assignee: TEKKA, Brignais (FR)

(21) Appl. No.: 13/022,715

(22) Filed: Feb. 8, 2011

Related U.S. Application Data
(63) Continuation of application No. 12/740,891, now abandoned.

(30) Foreign Application Priority Data
Oct. 31, 2007 (FR) 0707690

(51) Int. Cl. A61C 8/00

(52) U.S. Cl. 433/174; 433/173

(57) ABSTRACT

The present invention relates to a dental implant comprising an intra-bone anchorage footing which has means for fixing to a support post of a prosthetic tooth, characterized in that said fixing means comprises an internal frustoconical cavity made in the upper part of the footing of which the outer periphery has a beveled peripheral edge and the inner periphery has an indexing relief, and into which the homothetic base of said post is intended to fit.

### CROSS-REFERENCE TO RELATED APPLICATIONS

This application is a continuation of U.S. Ser. No. 12/740,891, filed on Oct. 31, 2008, which is a U.S. national stage application of PCT/FR2008/001543, filed on Oct. 31, 2008, which claims priority to French application serial number 0707690, filed on Oct. 31, 2007. The '891 application is hereby incorporated by reference.

### BACKGROUND

The present invention relates to a dental implant with a female frustoconical connector.

The present invention relates more particularly to the means of connection between the anchoring implant body of the implant and the post which supports the prosthetic tooth.

There are already many implants comprising an independent anchoring implant body provided with connection means for connection to the prosthetic tooth.

However, these connection means do not allow an adequate seal between the implant and the post. This causes problems with bacteriological contamination of the biological space between the implant, the bone and the gingiva. This contamination can cause inflammation of the gingiva and bone resorption.

Moreover, these connection means do not permit optimal transmission of the mechanical stresses to the whole of the implant. This deficiency can cause osseointegration problems and lead to failure of implantation.

Some implants have connection means in the form of female connectors.

However, these connectors either do not allow indexing of the prosthetic surfaces, which causes positioning and manipulation problems, or are unable to ensure optimal transmission of stresses.

It is an object of the present invention to solve these technical problems effectively and satisfactorily.

To this end, the implant of the present invention is characterized in that said connection means comprise an internal frustoconical cavity formed in the upper part of the implant body, of which the outer perimeter is provided with a chamfered peripheral edge and the inner perimeter with an indexing relief, said cavity being designed to receive, by insertion, the homothetic base of said post.

In accordance with an advantageous feature, said cavity is continued downward by a tapped axial hole designed to receive a screw for fixing said post.

In a specific variant, said indexing relief consists of lateral facets defining a hexagon.

In accordance with another feature, the wall of the cavity is separated longitudinally from the indexing relief by a circular groove.

In accordance with yet another feature, said implant body has a smooth upper neck which externally continues the chamfered edge in the downward direction.

Said neck preferably has cylindrical generatrices and is located above successively conical and cylindrical threaded portions of the implant body, the outside diameters of which are continuous.

In a particular variant, the cone angle of said cavity is between 7° and 9°.

In another variant said implant body has three screw threads.

In an advantageous embodiment of the implant, the post has an enlarged head with a lower shoulder.

This shoulder may optionally rest on the peripheral edge of said implant body.

Said post is preferably provided with an internal through bore in which a fixing screw is housed.

The implant of the invention makes it possible to produce a perfect seal between the implant body and the post, optimal load transfer, and good distribution of stresses.

The fixing of the post in the implant body is reversible but strong enough to prevent accidental detachment of the prosthetic tooth and ensure highly precise centering of the assembly.

The positioning of the post is indexed precisely to the connection means of the implant, allowing optimal adjustment of the prosthetic tooth in its housing.

Furthermore, the efficiency and precision of the indexing means of the invention assist with manipulation of the prosthetic surfaces during the transfer of information between the surgeon and the prosthetist.

Lastly, the absence of bacteriological release means that a neutral healthy biological space is preserved for gingival wound healing to take place and the best esthetic result is thus achieved.

The invention will be understood more clearly from the description given below, purely by way of explanation, of an embodiment of the invention, with reference to the appended figures, in which:

### BRIEF DESCRIPTION OF THE FIGURES

FIG. 1 is an exploded side view of one embodiment of the implant of the invention;

FIGS. 2A and 2B are a side view and section on II-II, respectively, of the implant body from FIG. 1;

FIG. 3 is a top view of the implant body from FIG. 1; and

FIG. 4 is a detail view in section of the implant body illustrated in FIG. 2.

### DETAILED DESCRIPTION

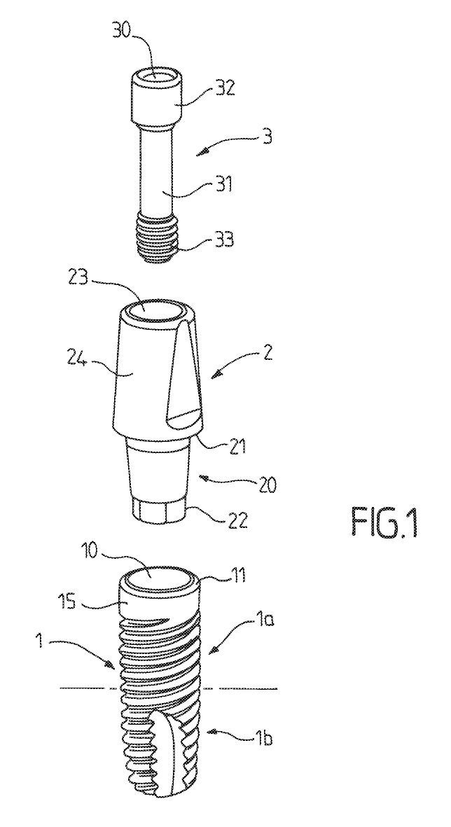

The implant of the invention is shown in FIG. 1.

This implant comprises an implant body 1, a post 2 for supporting a prosthetic tooth (not shown), and a fixing screw 3.

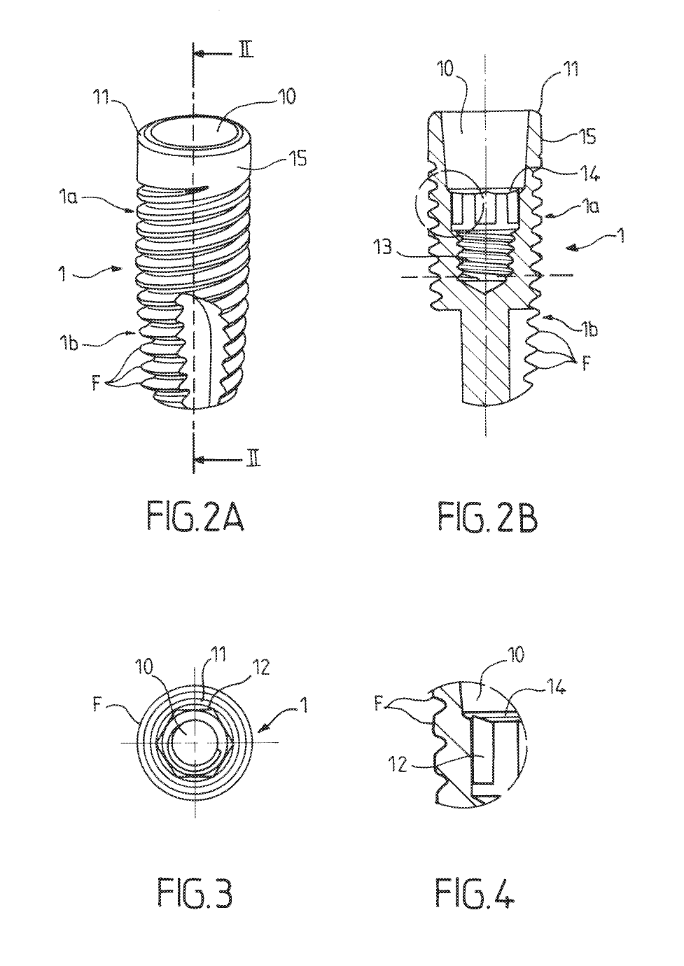

The implant body 1 used to anchor the implant according to the invention in a bony area of the jaw is more particularly illustrated in FIGS. 2A and 2B.

This implant body is provided with connection means for connecting it to the post for supporting the prosthetic tooth.

These connection means comprise an internal frustoconical cavity 10 formed in the upper part of the implant body 1, the outer perimeter of which is provided with a chamfered peripheral edge 11.

The cavity 10 is designed to receive, by insertion, the homothetic base 20 of the post of the prosthetic tooth.

The cavity 10 can be made in a separate component which in turn is attached to the inside of a bore inside the implant body, or may be formed directly in the implant body.

The depth of the cavity 10 is approximately 2.5 mm given an implant body height of between 6 and 19 mm, depending on the dimensions of the teeth to be fitted.

The cone angle of the cavity 10 and hence of the base 20 of the post is between 7° and 9°.

The inner perimeter of the cavity 10 is provided, at the bottom in the present case, with an indexing relief 12 depicted in FIG. 2B.

This relief consists, in the illustrated embodiment, of lateral facets defining a hexagon.

A complementary relief 22, here in the form of a hexagonal ring, is carried by the post 2 (see FIG. 1).

The mutual contact of the opposing facets with the two hexagonal reliefs 12, 22 guides the post into the cavity 10 and prevents it from rotating.

As shown in section in FIG. 2B, the cavity 10 is continued downward by a tapped axial hole 13 into which the fixing member 3 of the post 2 is intended to be screwed.

The wall of the cavity 10 is separated longitudinally from the indexing relief 12 by a circular groove 14.

The implant body 1 has a smooth upper neck 15 which continues laterally the chamfered edge 11 in the downward direction and, with the latter, promotes bone reconstruction in the implant site.

This neck 15 has cylindrical generatrices and is located above the successively cylindrical 1a and conical 1b threaded portions of the implant body 1, the outside diameters of which are continuous and do not therefore create a lateral discontinuity on the lateral face of the implant body.

These portions preferably have three screw threads F.

The implant body is surface-treated, e.g. by sand-blasting it with particles of corundum.

The post 2 has an enlarged head 24 with a lower shoulder 21.

During fitting, a gap of between 0.5 and 3 mm will be left between the lower shoulder 21 of the post and the top edge of the implant body to allow for gingival reconstruction.

The post is also provided with an internal through bore 23 in which the fixing screw 3 is housed.

The screw is composed of a shank 31 which has at its lower end a screw thread 33 which matches the internal thread 13 in the implant body, and, at its upper end, a drive means 32, which in the present case comprises a socket 30 for insertion of a wrench or screwdriver.

1. A dental implant of the type comprising an implant body (1) for endosseous anchorage, said implant body (1) being provided with connection means for connection to a supporting post (2) for a prosthetic tooth, said implant being characterized in that said connection means comprise an internal frustoconical cavity (10) formed in the upper part of the implant body (1), of which the outer perimeter is provided with a chamfered peripheral edge (11) and the inner perimeter with an indexing relief (12), said cavity (10) being designed to receive, by insertion, the homothetic base (20) of said post.

2. The implant as claimed in claim 1, characterized in that said cavity (10) is continued downward by a tapped axial hole (13) designed to receive a screw (3) for fixing said post.

3. The implant as claimed in claim 1, characterized in that said indexing relief (12) consists of lateral facets defining a hexagon.

4. The implant as claimed in claim 1, characterized in that the wall of the cavity (10) is separated longitudinally from the indexing relief (12) by a circular groove (14).

5. The implant as claimed in claim 1, characterized in that said implant body (1) has a smooth upper neck (15) which laterally continues the chamfered edge (11) in the downward direction.

6. The implant as claimed in claim 5, characterized in that said neck (15) has cylindrical generatrices and is located above successively cylindrical (1a) and conical (1b) threaded portions of the implant body (1), the outside diameters of which are continuous.

7. The implant as claimed in claim 1, characterized in that the cone angle of said cavity (10) is between 7° and 9°.

8. The implant as claimed in claim 1, characterized in that said implant body (1) has three screw threads (F).

9. The implant as claimed in claim 1, characterized in that said post (2) has an enlarged head (24) with a lower shoulder (21).

10. The implant as claimed in claim 1, characterized in that said post (2) is provided with an internal through bore (23) in which a fixing screw (3) is housed.
